(19) United States
(12) Patent Application Publication
(10) Pub. No.: US 2026/0064136 A1
(43) Pub. Date: Mar. 5, 2026

(54) FLOW RATE ADJUSTING DEVICE, FLOW RATE ADJUSTING SYSTEM, AND CONTROL METHOD OF FLOW RATE ADJUSTING DEVICE

(71) Applicant: Surpass Industry Co., Ltd., Gyoda-shi (JP)

(72) Inventor: Taku SHIBATA, Saitama (JP)

(73) Assignee: Surpass Industry Co., Ltd., Gyoda-shi (JP)

(21) Appl. No.: 19/299,046

(22) Filed: Aug. 13, 2025

(30) Foreign Application Priority Data
Aug. 28, 2024 (JP) 2024-146113

(51) Int. Cl. G05D 7/06

(52) U.S. Cl. CPC G05D 7/0635

(57) ABSTRACT

Provided is a flow rate adjusting device including: a flow metering portion that measures a liquid flow rate; a flow rate adjusting portion that moves a valve body relative to a valve hole to adjust a flow rate of a liquid flowing out of the measurement flow channel; a flow rate setting unit that sets a set flow rate value; and a control unit. The control unit controls the flow rate adjusting portion to move the valve body to a target position that varies with a difference between a measured flow rate value and the set flow rate value so that both the values are matched when performing the flow rate adjusting mode and controls the flow rate adjusting portion to move and then maintain the valve body to and at a standby position where the valve body is not in contact with the valve hole when performing the standby mode.

### CROSS-REFERENCE TO RELATED APPLICATIONS

This application claims foreign priority benefits under U.S.C. §119 to Japanese Patent Application No. 2024-146113 filed on August 28, 2024, the contents of which is hereby incorporated by reference in its entirety.

### BACKGROUND

### 1. Technical Field

The present disclosure relates to a flow rate adjusting device, a flow rate adjusting system, and a control method of a flow rate adjusting device.

### 2. Description of Related Art

Flow rate adjusting devices that includes a flow metering portion configured to measure the flow rate of a liquid and moves a valve body in a direction closer to or away from a valve hole to adjust the flow rate of a liquid passing through the valve hole so that the flow rate measured by the flow metering portion is a set flow rate set in advance are conventionally known (for example, see Japanese Patent Application Laid-Open No. 2017-138200).

For example, the flow rate adjusting device disclosed in Japanese Patent Application Laid-Open No. 2017-138200 is supplied with a liquid discharged from a pump installed upstream via piping, adjusts a flow rate of the supplied liquid, and discharges the liquid to piping installed downstream. The liquid discharged from the flow rate adjusting device flows out of an outflow end installed at the downstream end of the piping. The flow rate adjusting device is incorporated as a part of a flow rate adjusting system including a pump configured to draw a liquid from an inflow end and discharge the liquid and piping installed upstream and downstream of the flow rate adjusting device.

When the flow rate adjusting system stops delivery of a liquid from the inflow end to the outflow end, for example, the pump is stopped, an on-off valve arranged in the piping installed upstream of the flow rate adjusting device is closed, and an on-off valve arranged in the piping installed downstream of the flow rate adjusting device is closed.

For example, the flow rate adjusting device remains to hold the position of the valve body given at the time of stopping the flow rate adjusting system. In such a case, since the on-off valves arranged upstream and downstream of the flow rate adjusting device remain to be closed, a state where the flow rate adjusting system stops delivery of a liquid from the inflow end to the outflow end is maintained even when the position of the valve body is retained.

However, for example, when the position of the valve body at the time of stopping the flow rate adjusting system is not appropriate and the opening thereof is thus excessively large, this may result in occurrence of an overshoot in which the liquid flow rate is excessively larger relative to a targeted flow rate when the flow rate adjusting system resumes the delivery of the liquid from the inflow end to the outflow end. Further, for example, when the position of the valve body at the time of stopping the flow rate adjusting system is not appropriate and the opening is thus excessively small (for example, fully closed), a control delay may occur in which it takes a longer time for the liquid flow rate to reach a targeted flow rate when the flow rate adjusting system resumes the delivery of the liquid from the inflow end to the outflow end.

### BRIEF SUMMARY

The present disclosure has been made in view of such circumstances and intends to provide a flow rate adjusting device, a flow rate adjusting system, and a control method of a flow rate adjusting device that can prevent an overshoot or a control delay relative to a set flow rate value from occurring when switching a standby mode to a flow rate adjusting mode.

The present disclosure employs the following solutions in order to solve the problem described above. A flow rate adjusting device according to the present disclosure includes: a flow metering portion configured to measure a flow rate of a liquid flowing through a measurement flow channel; a flow rate adjusting portion configured to move a valve body along an axis in a direction closer to or away from a valve hole to adjust a flow rate of a liquid flowing out of the measurement flow channel; a flow rate setting unit configured to set a set flow rate value of a liquid to be adjusted by the flow rate adjusting portion; and a control unit configured to control the flow rate adjusting portion in either a flow rate adjusting mode or a standby mode, and the control unit, when performing the flow rate adjusting mode, controls the flow rate adjusting portion to move the valve body to a target position that varies in accordance with a flow rate difference between a measured flow rate value of a liquid measured by the flow metering portion and the set flow rate value so that the measured flow rate value matches the set flow rate value, and when performing the standby mode, controls the flow rate adjusting portion to move the valve body to a standby position and then maintain the standby position, the valve body being not in contact with the valve hole at the standby position.

According to the flow rate adjusting device of the present disclosure, when performing the standby mode switched from the flow rate adjusting mode, the control unit controls the flow rate adjusting portion to move the valve body to a standby position at which the valve body is not in contact with the valve hole and then maintain the standby position. Since the position at which the valve body is not in contact with the valve hole is the standby position, the opening is larger than that in the fully closed position at which the valve body is in contact with the valve hole. Thus, the flow rate better follows the set flow rate value than in the case where the flow rate adjusting mode is applied via switching from the fully closed position, and this can prevent a control delay from occurring. Further, even when the valve body at the switching from the flow rate adjusting mode to the standby mode is excessively spaced away from the valve hole resulting in an excessively large opening, the valve body is moved to the standby position, and this standby position is maintained. Thus, an overshoot due to the excessively large opening of the valve body can be prevented from occurring when the standby mode is switched to the flow rate adjusting mode.

The flow rate adjusting device according to the present disclosure may be configured such that the target position is set between a lower limit position and an upper limit position, the lower limit position corresponding to a lower limit value of the set flow rate value, the upper limit position corresponding to an upper limit value of the set flow rate value, and the flow rate setting unit being configured to set the lower limit value and the upper limit value, and the standby position is a position more spaced away from the valve hole than the lower limit position.

According to the flow rate adjusting device of the present configuration, since the standby position is a position more spaced away from the valve hole than the lower limit position, the flow rate better follows the set flow rate value than in the case where the flow rate adjusting mode is applied via switching from the lower limit position, and this can prevent a control delay from occurring.

The flow rate adjusting device according to the present disclosure may be configured to include a standby position setting unit configured to set the standby position at a predetermined position between the lower limit position and the upper limit position.

According to the flow rate adjusting device of the present configuration, because the standby position is set to a predetermined position between the lower limit position and the upper limit position by the standby position setting unit, an overshoot or a control delay can be suitably prevented from occurring when the standby mode is switched to the flow rate adjusting mode.

The flow rate adjusting device according to the present disclosure may be configured such that the control unit switches the standby mode to the flow rate adjusting mode in response to receiving a first switching signal from a higher-level device, the first switching signal being for switching the standby mode to the flow rate adjusting mode, and switches the flow rate adjusting mode to the standby mode in response to receiving a second switching signal from the higher-level device, the second switching signal being for switching the flow rate adjusting mode to the standby mode.

According to the flow rate adjusting device of the present configuration, switching between the flow rate adjusting mode and the standby mode can be suitably performed in accordance with the first switching signal and the second switching signal received from the higher-level device.

The flow rate adjusting device of the configuration described above may be formed such that the flow rate setting unit sets the set flow rate value based on a flow rate setting signal transferred from the higher-level device, the flow rate setting signal being for setting the set flow rate value, and the control unit sets the standby position based on a standby position setting signal transferred from the higher-level device, the standby position setting signal being for setting the standby position.

According to the flow rate adjusting device of the present form, the set flow rate value can be set based on the flow rate setting signal transferred from the higher-level device, and the standby position can be set based on the standby position setting signal transferred from the higher-level device.

A flow rate adjusting system according to the present disclosure is a flow rate adjusting system including: a flow rate adjusting device; and a higher-level device configured to control the flow rate adjusting device. The flow rate adjusting device includes: a flow metering portion configured to measure a flow rate of a liquid flowing through a measurement flow channel; a flow rate adjusting portion configured to move a valve body along an axis in a direction closer to or away from a valve hole to adjust a flow rate of a liquid flowing out of the measurement flow channel; a flow rate setting unit configured to set a set flow rate value of a liquid to be adjusted by the flow rate adjusting portion; and a control unit configured to control the flow rate adjusting portion in either a flow rate adjusting mode or a standby mode, and the control unit, when performing the flow rate adjusting mode, controls the flow rate adjusting portion to move the valve body to a target position that varies in accordance with a flow rate difference between a measured flow rate value of a liquid measured by the flow metering portion and the set flow rate value so that the measured flow rate value matches the set flow rate value, and when performing the standby mode, controls the flow rate adjusting portion to move the valve body to a standby position and then maintain the standby position, the valve body being not in contact with the valve hole at the standby position. The higher-level device includes: a mode transfer unit configured to transfer a first switching signal and a second switching signal to the flow rate adjusting device, the first switching signal being for switching the flow rate adjusting device from the standby mode to the flow rate adjusting mode, and the second switching signal being for switching the flow rate adjusting device from the flow rate adjusting mode to the standby mode; a flow rate transfer unit configured to transfer a flow rate setting signal to the flow rate adjusting device, the flow rate setting signal being for setting the set flow rate value; and a standby position transfer unit configured to transfer a standby position setting signal to the flow rate adjusting device, the standby position setting signal being for setting the standby position, and the standby position transfer unit transfers the standby position setting signal to the flow rate adjusting device so that the standby position in a predetermined standby mode varies in accordance with the set flow rate value in the flow rate adjusting mode performed subsequent to the predetermined standby mode.

According to the flow rate adjusting system of the present disclosure, when performing the standby mode switched from the flow rate adjusting mode, the control unit of the flow rate adjusting device controls the flow rate adjusting portion to move the valve body to a standby position at which the valve body is not in contact with the valve hole and then maintain the standby position. Since the position at which the valve body is not in contact with the valve hole is the standby position, the opening is larger than that in the fully closed position at which the valve body is in contact with the valve hole. Thus, the flow rate better follows the set flow rate value than in the case where the flow rate adjusting mode is applied via switching from the fully closed position, and this can prevent a control delay from occurring. Further, even when the valve body at the switching from the flow rate adjusting mode to the standby mode is excessively spaced away from the valve hole resulting in an excessively large opening, the valve body is moved to the standby position, and the standby position is maintained. Thus, an overshoot due to the excessively large opening can be prevented from occurring when the standby mode is switched to the flow rate adjusting mode.

Further, according to the flow rate adjusting system of the present disclosure, standby position transfer unit of the higher-level device transfers the standby position setting signal to the flow rate adjusting device so that the standby position in a predetermined standby mode varies in accordance with the set flow rate value in a flow rate adjusting mode performed subsequently to the predetermined standby mode. Since the standby position is a position in accordance with the set flow rate value in the flow rate adjusting mode when a predetermined standby mode is switched to a flow rate adjusting mode, an overshoot or a control delay can be suitably prevented from occurring.

The flow rate adjusting system according to the present disclosure may be configured to include a temperature detecting unit configured to determine a temperature of a liquid passing through the flow rate adjusting device and may be configured such that the standby position transfer unit transfers the standby position setting signal to the flow rate adjusting device so that a distance along the axis from the valve hole to the standby position is increased in accordance with a rise in the temperature of the liquid determined by the temperature detecting unit.

According to the flow rate adjusting system of the present configuration, since the distance along the axis from the valve hole to the standby position is increased in accordance with a rise in the liquid temperature determined by the temperature detecting unit, it is possible to suitably prevent a failure that would otherwise be caused by that the valve body or the valve hole expands and the valve body and the valve hole come closer or come into contact with each other due to a rise in the liquid temperature.

The flow rate adjusting system according to the present disclosure may be configured to include a pressure detecting unit configured to determine a pressure of a liquid flowing into the flow rate adjusting device and may be configured such that the standby position transfer unit transfers the standby position setting signal to the flow rate adjusting device so that a distance along the axis from the valve hole to the standby position is reduced in accordance with a rise in the pressure of the liquid determined by the pressure detecting unit.

According to the flow rate adjusting system of the present configuration, since the distance along the above axis from the valve hole to the standby position is reduced in accordance with a rise in the liquid pressure determined by the pressure detecting unit, it is possible to suitably prevent the liquid flow rate from being excessively larger due to a rise in the liquid pressure.

In a control method of a flow rate adjusting device according to the present disclosure, the flow rate adjusting device includes a flow metering portion configured to measure a flow rate of a liquid flowing through a measurement flow channel, a flow rate adjusting portion configured to move a valve body along an axis in a direction closer to or away from a valve hole to adjust a flow rate of a liquid flowing out of the measurement flow channel, and a flow rate setting unit configured to set a set flow rate value of a liquid to be adjusted by the flow rate adjusting portion, and the control method includes: a flow rate adjusting step of controlling the flow rate adjusting portion to move the valve body to a target position that varies in accordance with a flow rate difference between a measured flow rate value of a liquid measured by the flow metering portion and the set flow rate value so that the measured flow rate value matches the set flow rate value; and a standby step of controlling the flow rate adjusting portion to move the valve body to a standby position and then maintain the standby position, the valve body being not in contact with the valve hole at the standby position.

According to the control method of the flow rate adjusting device of the present disclosure, in the standby step, the flow rate adjusting portion is controlled to move the valve body to a standby position at which the valve body is not in contact with the valve hole and then maintain the standby position. Since the position at which the valve body is not in contact with the valve hole is the standby position, the opening is larger than that in the fully closed position at which the valve body is in contact with the valve hole. Thus, the flow rate better follows the set flow rate value than in the case where the flow rate adjusting step is performed from the fully closed position, and this can prevent a control delay from occurring. Further, even when the valve body at the switching from the flow rate adjusting step to the standby step is excessively spaced away from the valve hole resulting in an excessively large opening, the valve body is moved to the standby position, and the standby position is maintained. Thus, an overshoot due to the excessively large opening can be prevented from occurring when the standby step is switched to the flow rate adjusting step.

According to the present disclosure, it is possible to provide a flow rate adjusting device, a flow rate adjusting system, and a control method of a flow rate adjusting device that can prevent an overshoot or a control delay relative to a set flow rate value from occurring when switching a standby mode to a flow rate adjusting mode.

### BRIEF DESCRIPTION OF THE SEVERAL VIEWS OF THE DRAWINGS

FIG. 1 is a partial longitudinal sectional view illustrating one embodiment of a flow rate adjusting device.

FIG. 2 is a partial longitudinal sectional view illustrating an ultrasonic flow metering portion illustrated in FIG. 1.

FIG. 3 is a partial longitudinal sectional view illustrating a flow rate adjusting portion and an outflow-side flow channel portion illustrated in FIG. 1.

FIG. 4 is a longitudinal sectional view illustrating an inflow-side flow channel portion and a pressure sensor illustrated in FIG. 1.

FIG. 5 is a block diagram illustrating a configuration of a control device.

FIG. 6 is a schematic configuration diagram illustrating a flow rate adjusting system in which the flow rate adjusting device is installed.

FIG. 7 is a block diagram illustrating a configuration of a higher-level device.

FIG. 8 is a flowchart illustrating an operation performed by the higher-level device.

FIG. 9 is a flowchart illustrating an operation performed by the flow rate adjusting device.

FIG. 10 is a graph illustrating an example of a change in the opening of a valve body.

FIG. 11 is a schematic configuration diagram illustrating a flow rate adjusting system according to a first modified example of the present disclosure.

FIG. 12 is a schematic configuration diagram illustrating a flow rate adjusting system according to a second modified example of the present disclosure.

FIG. 13 is a schematic configuration diagram illustrating a flow rate adjusting system according to a third modified example of the present disclosure.

### DETAILED DESCRIPTION

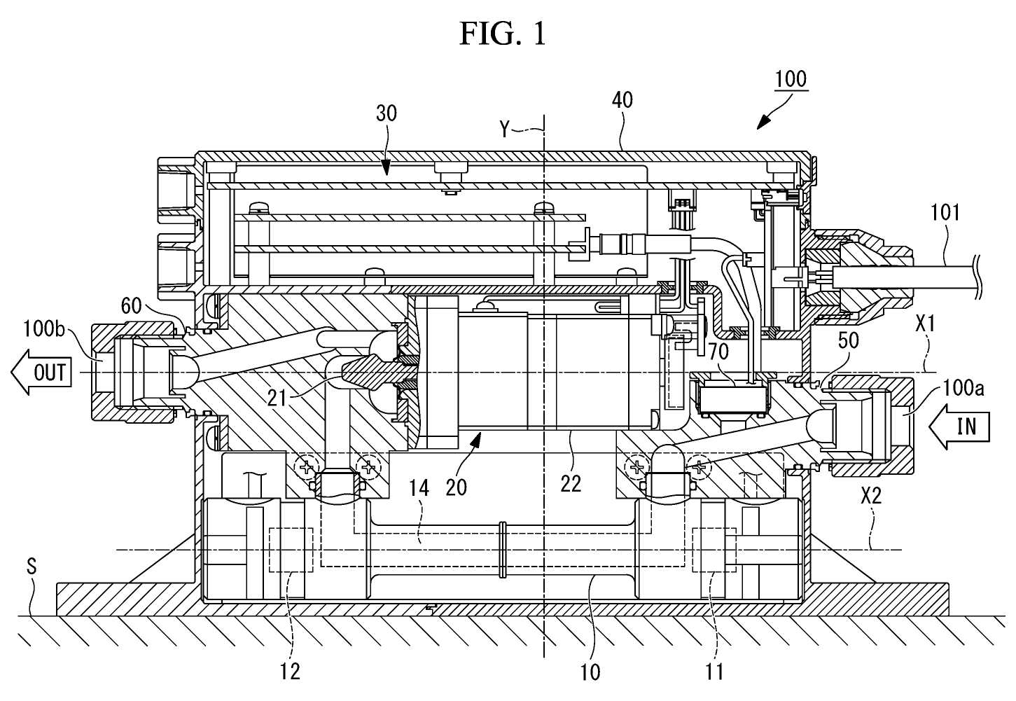

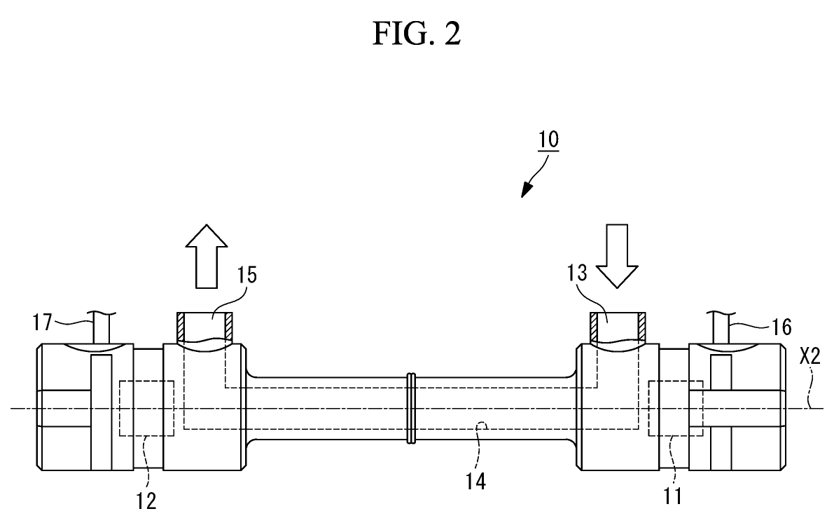

A flow rate adjusting device 100 of one embodiment of the present disclosure will be described below with reference to the drawings. FIG. 1 is a partial longitudinal sectional view illustrating one embodiment of the flow rate adjusting device 100. FIG. 2 is a partial longitudinal sectional view illustrating an ultrasonic flow metering portion 10 illustrated in FIG. 1.

The flow rate adjusting device 100 of this embodiment shown in FIG. 1 includes: an ultrasonic flow metering portion 10 which measures a flow rate of a liquid flowing in from an inflow port 100a and circulated through a straight tube-shaped measurement flow channel 14; a flow rate adjusting portion 20 which adjusts the flow rate of the liquid; a control device 30 which controls the flow rate adjusting portion 20; a housing portion 40 which accommodates the ultrasonic flow metering portion 10, the flow rate adjusting portion 20, the control device 30; an inflow-side flow channel portion 50 which guides the fluid flowing in from the inflow port 100a to an upstream side of the measurement flow channel 14; an outflow-side flow channel portion 60 which guides the fluid flowing out from a downstream side of the measurement flow channel 14 to an outflow port 100b; a pressure sensor (pressure measuring portion) 70; and a shield member 80.

The fluid whose flow rate is adjusted by the flow rate adjusting device 100 of this embodiment is, for example, a drug solution or pure water used for semiconductor manufacturing devices. The temperature of the fluid is, for example, a temperature in an ordinary temperature range (for example, 10°C or higher and lower than 50°C) or a high-temperature range (for example, 50°C or higher and 80°C or lower).

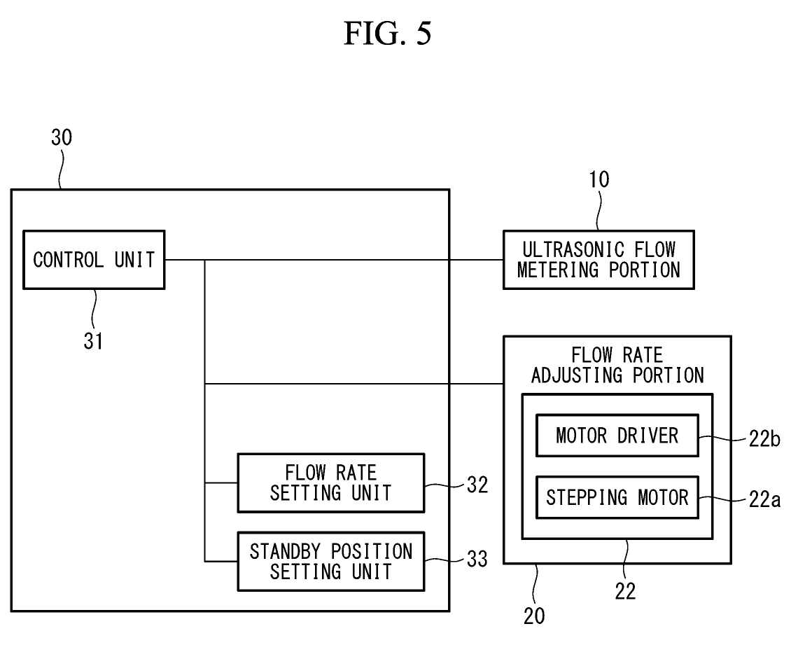

The housing portion 40 of the flow rate adjusting device 100 is fixed to an installation surface S with fastening bolts (not shown). The flow rate adjusting device 100 is connected to a higher-level device 200 (see FIG. 5) via a cable 101, is supplied with power from the external device via the cable 101, and transmits various signals to the higher-level device 200 and receives various signals therefrom.

Examples of the signals received from the higher-level device 200 include a flow rate setting signal indicating a set value of a target flow rate adjusted by the flow rate adjusting device 100. Examples of the signals transmitted to the higher-level device 200 include a signal indicating the flow rate of the liquid calculated by the control device 30 on the basis of s signal measured by the ultrasonic flow metering portion 10, and a signal indicating the pressure of the liquid measured by the pressure sensor 70.

The ultrasonic flow metering portion 10 measures a propagation time difference between ultrasonic waves transmitted by a pair of oscillators, i.e., an upstream side oscillator 11 disposed at the upstream side of the measurement flow channel 14 and a downstream side oscillator 12 disposed at the downstream side of the measurement flow channel 14, so as to obtain the flow rate of the liquid which flows in from an inflow-side pipe (not shown) and is circulated through the straight tube-shaped measurement flow channel 14.

As shown in FIG. 2, the ultrasonic flow metering portion 10 includes: the upstream side oscillator 11 and the downstream side oscillator 12 which are disposed on an axis line X2 that is parallel to the installation surface S; an inflow channel 13 which is connected to the inflow-side flow channel portion 50; the straight tube-shaped measurement flow channel 14 which is connected to the inflow channel 13 and extends along the axis line X2 (second axis line); and an outflow channel 15 which is connected to the outflow-side flow channel portion 60. The axis line X2 is parallel to an axis line X1 (first axis line) in which a valve body 21, which is described later, advances or recedes.

The upstream side oscillator 11 and the downstream side oscillator 12 are disposed at positions opposed to each other across the measurement flow channel 14 on the axis line X2, and can transmit and receive ultrasonic wave signals. The ultrasonic wave signal transmitted from the upstream side oscillator 11 propagates through the fluid circulated through the measurement flow channel 14 and is received by the downstream side oscillator 12.

Similarly, the ultrasonic wave signal transmitted from the downstream side oscillator 12 propagates through the fluid circulated through the measurement flow channel 14 and is received by the upstream side oscillator 11. Since the fluid is circulated through the measurement flow channel 14 from the upstream side to the downstream side, a propagation time for the ultrasonic wave signal transmitted from the upstream side oscillator 11 to the downstream side oscillator 12 is shorter than a propagation time for the ultrasonic wave signal transmitted from the downstream side oscillator 12 to the upstream side oscillator 11. The ultrasonic flow metering portion 10 measures the flow rate of the fluid circulated through the measurement flow channel 14 by using a difference between the propagation times.

Note that the transmission of the ultrasonic wave signals by the upstream side oscillator 11 and the downstream side oscillator 12 is controlled by the control device 30 which is connected to the upstream side oscillator 11 and the downstream side oscillator 12 with signal lines 16 and 17, respectively, which are shown in FIG. 2. The ultrasonic wave signals received by the upstream side oscillator 11 and the downstream side oscillator 12 are transmitted to the control device 30 via the signal lines 16 and 17. As described later, the control device 30 calculates a difference between propagation times from transmission timings for the ultrasonic wave signals that are sent as instructions to the upstream side oscillator 11 and the downstream side oscillator 12 and reception timings for the ultrasonic wave signals received from the upstream side oscillator 11 and the downstream side oscillator 12 according to the transmission timings, and also calculates the flow rate of the fluid from the calculated difference between propagation times.

The flow rate adjusting portion 20 adjusts the flow rate of the liquid flowing out to the outflow port 100b which is connected to an outflow-side pipe (not shown) via the outflow-side flow channel portion 60 from the downstream side of the measurement flow channel 14. As shown in FIG. 1, the flow rate adjusting portion 20 is disposed between the ultrasonic flow metering portion 10 and the control device 30 in an axis line Y direction corresponding to an installation direction orthogonal to the installation surface S. As shown in FIG. 1, in the axis line Y direction, the ultrasonic flow metering portion 10 is disposed at a position closest to the installation surface S, and the control device 30 is disposed at a position farthest from the installation surface S. The flow rate adjusting portion 20 is disposed between the ultrasonic flow metering portion 10 and the control device 30.

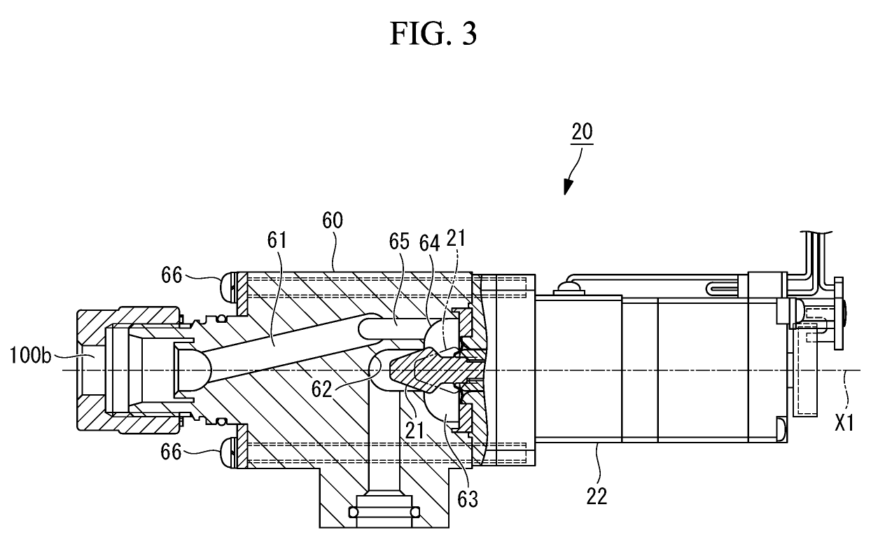

FIG. 3 is a partial longitudinal sectional view illustrating the flow rate adjusting portion 20 and the outflow-side flow channel portion 60 illustrated in FIG. 1. As illustrated in FIG. 3, the flow rate adjusting portion 20 has a valve body 21 inserted in a valve hole 62 formed in the outflow-side flow channel portion 60 and an electric drive portion 22 configured to move the valve body 21 in a direction closer to or away from the valve hole 62 along an axis X1 (first axis) parallel to the installation face S. The flow rate adjusting portion 20 moves the valve body 21 toward or away from the valve hole 62 along the axis X1 to adjust the flow rate of the liquid flowing out of the measurement flow channel 14.

The electric drive portion 22 moves the valve body 21 forward or backward along the axis X1 between a position of a closed state illustrated by the solid line in FIG. 3 and a position of an open state illustrated by the dashed line in FIG. 3. The flow rate adjusting portion 20 adjusts the amount of a fluid flowing into the valve chamber 63 from the valve hole 62 by adjusting the position of the valve body 21 on the axis X1 by the electric drive portion 22.

Herein, the configuration of the control device 30 will be described with reference to FIG. 5. FIG. 5 is a block diagram illustrating the configuration of the control device 30. As illustrated in FIG. 5, the control device 30 has a control unit 31, a flow rate setting unit 32, and a standby position setting unit 33. The control unit 31 controls the ultrasonic flow metering portion 10, the flow rate adjusting portion 20, the flow rate setting unit 32, and the standby position setting unit 33.

The control unit 31 controls the flow rate adjusting portion 20 based on a measured flow rate value FRac of a liquid measured by the ultrasonic flow metering portion 10. The control unit 31 controls the flow rate adjusting portion 20 in either a flow rate adjusting mode or a standby mode.

When performing the flow rate adjusting mode, the control unit 31 controls the flow rate adjusting portion 20 to move the valve body 21 to a target position that varies in accordance with a flow rate difference between a measured flow rate value FRac measured by the ultrasonic flow metering portion 10 and a set flow rate value FRset set by the flow rate setting unit 32, so that the measured flow rate value FRac matches the set flow rate value FRset. When performing the standby mode, the control unit 31 controls the flow rate adjusting portion 20 to move the valve body 21 to a standby position and then maintain the standby position, the valve body 21 being not in contact with the valve hole 62 at the standby position.

The control unit 31 can instruct the upstream side oscillator 11 and the downstream side oscillator 12, respectively, which are included in the ultrasonic flow metering portion 10, to transmit ultrasonic wave signals. Further, the control unit 31 can detect a timing when the ultrasonic wave signal transmitted from one of the upstream side oscillator 11 and the downstream side oscillator 12 is received by the other one of the upstream side oscillator 11 and the downstream side oscillator 12.

The control unit 31 calculates a first propagation time from the transmission timing for the ultrasonic wave signal that is sent as an instruction to the downstream side oscillator 12 and the reception timing for the ultrasonic wave signal received by the upstream side oscillator 11 according to the transmission timing. Further, the control device 30 calculates a second propagation time from the transmission timing for the ultrasonic wave signal that is sent as an instruction to the upstream side oscillator 11 and the reception timing for the ultrasonic wave signal received by the downstream side oscillator 12 according to the transmission timing. The control unit 31 obtains the flow rate of the liquid circulated through the measurement flow channel 14 on the basis of a predetermined flow rate arithmetic expression and a propagation time difference obtained by subtracting the second propagation time from the first propagation time.

The flow rate setting unit 32 sets a set flow rate value FRset [ml/min] included in a flow rate range of the minimum flow rate, 0 [ml/min], to the maximum flow rate FRmax [ml/min] of the flow rate adjusting device 100. For example, the flow rate setting unit 32 sets the set flow rate value FRset based on a flow rate setting signal received by the control device 30 from the higher-level device 200 via the cable 101.

The standby position setting unit 33 sets the standby position at a predetermined position between the closed position (lower limit position) corresponding to the minimum flow rate 0 (lower limit value) of the flow rate setting value FRset that can be set by the flow rate setting unit 32 and the upper limit position corresponding to the maximum flow rate FRmax (upper limit value) of the flow rate setting value FRset that can be set by the flow rate setting unit 32. The standby position is the position at which the valve body 21 is held in standby when the control unit 31 performs the standby mode described below.

The electric drive portion 22 of the flow rate adjusting portion 20 has a stepping motor 22a that rotates about the axis X1 to move the valve body 21 along the axis X1 and a motor driver 22b that generates excitation current used for driving the stepping motor 22a and outputs the excitation current to the stepping motor 22a.

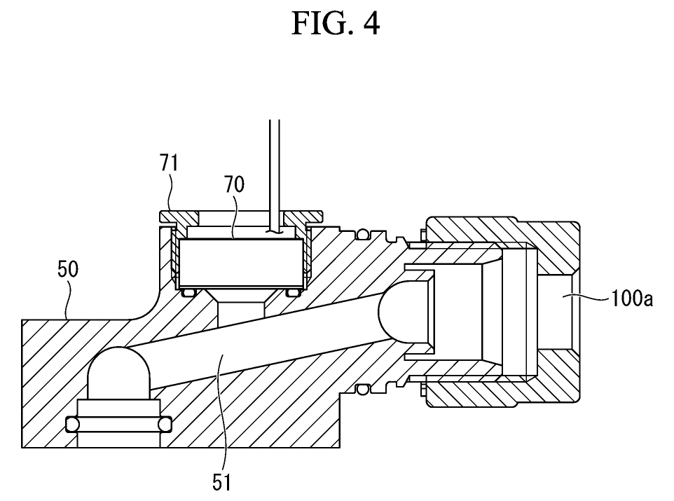

FIG. 4 is a longitudinal sectional view illustrating the inflow-side flow channel portion 50 and the pressure sensor 70 illustrated in FIG. 1. As shown in FIGS. 1 and 4, the inflow-side flow channel portion 50 is a member in which an inflow-side inclined flow channel 51 that is inclined in a direction approaching the installation surface S from the inflow port 100a to the upstream side inflow channel 13 of the measurement flow channel 14 is formed inside. The inflow-side flow channel portion 50 is provided with the pressure sensor 70 for detecting the pressure of the liquid circulated through the inflow-side inclined flow channel 51.

As shown in FIGS. 1 and 3, the outflow-side flow channel portion 60 is a member in which an outflow-side inclined flow channel 61 that is inclined in a direction approaching the installation surface S from the flow rate adjusting portion 20 to the outflow port 100b is formed inside. The outflow-side flow channel portion 60 guides the fluid to the upstream side of the outflow-side inclined flow channel 61 via an outflow channel 65 from an opening 64 that is formed at an upper portion of the valve chamber 63. The liquid guided to the upstream side of the outflow-side inclined flow channel 61 is further guided to the outflow port 100b along the outflow-side inclined flow channel 61. As shown in FIGS. 2 and 3, the outflow-side flow channel portion 60 is provided with through-holes through which a plurality of fastening bolts 66 penetrate. The outflow-side flow channel portion 60 is fixed to the electric driving portion 22 by fastening the fastening bolts 66 to the electric driving portion 22.

The pressure sensor 70 measures the pressure (supply pressure) of the liquid flowing into the inflow-side inclined flow channel 51 at the upstream side of the measurement flow channel 14 from the inflow port 100a. The pressure sensor 70 is, for example, a strain gauge pressure sensor. As shown in FIG. 4, the pressure sensor 70 is attached to the inflow-side flow channel portion 50 by a sensor holder 71. A pressure signal indicating the pressure of the liquid measured by the pressure sensor 70 is transmitted to the control device 30 and stored in a storage portion (not shown) included in the control device 30. The pressure signal is transmitted to the higher-level device 200 via the cable 101.

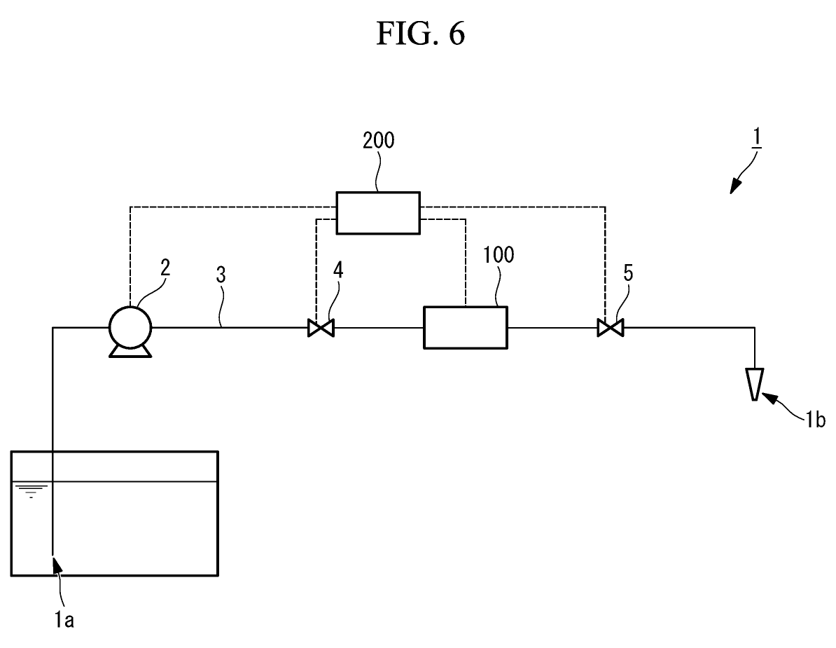

Next, a flow rate adjusting system 1 in which the flow rate adjusting device 100 of the present embodiment is installed will be described with reference to FIG. 6. FIG. 6 is a schematic configuration diagram illustrating the flow rate adjusting system 1 in which the flow rate adjusting device 100 is installed. As illustrated in FIG. 6, the flow rate adjusting system 1 has a pump 2 configured to pressurize and feed a liquid, a piping 3 configured to convey a liquid from an inflow end 1a to an outflow end 1b, the flow rate adjusting device 100, an on-off valve 4 arranged in the piping 3 upstream of the flow rate adjusting device 100, an on-off valve 5 arranged in the piping 3 downstream of the flow rate adjusting device 100, and a higher-level device 200. The higher-level device 200 is a device that controls the flow rate adjusting device 100, the pump 2, the on-off valve 4, and the on-off valve 5.

The flow rate adjusting system 1 causes the pump 2 to pressurize and feed a liquid flowing into the piping 3 from the inflow end 1a to supply the fluid to the flow rate adjusting device 100 and supplies the fluid with the flow rate adjusted by the flow rate adjusting device 100 to the outflow end 1b. A state where a liquid is supplied from the inflow end 1a to the flow rate adjusting device 100 and a state where no fluid is supplied from the inflow end 1a to the flow rate adjusting device 100 are switched therebetween by the on-off valve 4. A state where a liquid is supplied from the flow rate adjusting device 100 to the outflow end 1b and a state where no liquid is supplied from the flow rate adjusting device 100 to the outflow end 1b are switched therebetween by the on-off valve 5.

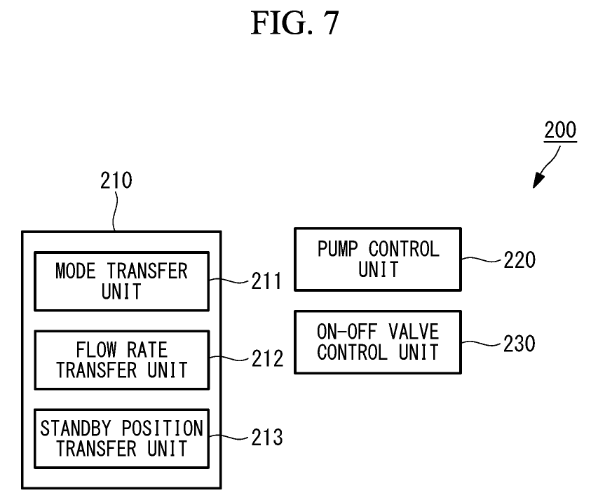

FIG. 7 is a block diagram illustrating a configuration of the higher-level device 200. As illustrated in FIG. 7, the higher-level device 200 has a flow rate adjusting control unit 210, a pump control unit 220 configured to control the pump 2, and an on-off valve control unit 230 configured to control the on-off valve 4 and the on-off valve 5. The flow rate adjusting control unit 210 has a mode transfer unit 211, a flow rate transfer unit 212, and a standby position transfer unit 213.

The mode transfer unit 211 transfers a first switching signal, which switches the flow rate adjusting device 100 from a standby mode to a flow rate adjusting mode, and a second switching signal, which switches the flow rate adjusting device 100 from the flow rate adjusting mode to the standby mode, to the flow rate adjusting device 100 via the cable 101. The flow rate transfer unit 212 transfers a flow rate setting signal used for setting the set flow rate value FRset to the flow rate adjusting device 100 via the cable 101. The standby position transfer unit 213 transfers a standby position setting signal used for setting a standby position to the flow rate adjusting device 100 via the cable 101.

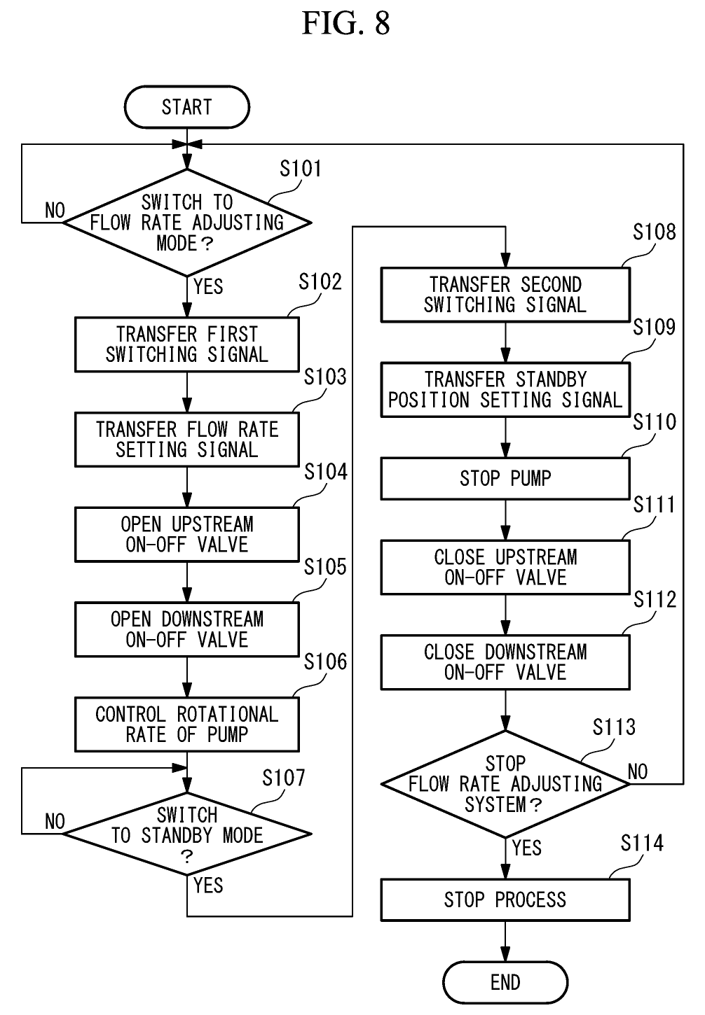

Next, the operation performed by the higher-level device 200 of the flow rate adjusting system 1 will be described with reference to FIG. 8. FIG. 8 is a flowchart illustrating the operation performed by the higher-level device 200.

In step S101, the flow rate adjusting control unit 210 determines whether or not to switch the flow rate adjusting device 100 from the standby mode to the flow rate adjusting mode and, if the determination is YES, proceeds with the process of step S102 or, if the determination is NO, repeats the process of step S101.

In step S102, the mode transfer unit 211 transfers the first switching signal, which switches the flow rate adjusting device 100 from the standby mode to the flow rate adjusting mode, to the flow rate adjusting device 100. In step S103, the flow rate transfer unit 212 transfers the flow rate setting signal, which is for setting the set flow rate value FRset, to the flow rate adjusting device 100.

In step S104, the on-off valve control unit 230 controls the on-off valve 4 upstream of the flow rate adjusting device 100 so that the on-off valve 4 enters an open state. In step S105, the on-off valve control unit 230 controls the on-off valve 5 downstream of the flow rate adjusting device 100 so that the on-off valve 5 enters an open state.

In step S106, the pump control unit 220 starts the operation of the pump 2 and controls the pump 2 to be operated at a desired rotational rate.

In step S107, the flow rate adjusting control unit 210 determines whether or not to switch the flow rate adjusting device 100 from the flow rate adjusting mode to the standby mode and, if the determination is YES, proceeds with the process of step S108 or, if the determination is NO, repeats the process of step S107.

In step S108, the mode transfer unit 211 transfers the second switching signal, which switches the flow rate adjusting device 100 from the flow rate adjusting mode to the standby mode, to the flow rate adjusting device 100. In step S109, the standby position transfer unit 213 transfers the standby position setting signal, which is for setting a standby position at which the valve body 21 is caused to stand by, to the flow rate adjusting device 100 when the flow rate adjusting device 100 is operated in the standby mode.

For example, it is preferable for the standby position transfer unit 213 to correct the standby position setting signal so that the distance along the axis X1 from the valve hole 62 to the standby position becomes longer as the temperature of a liquid supplied to the flow rate adjusting device 100 rises. This is because a higher liquid temperature causes a higher likelihood of the valve body 21 or the valve hole 62 expanding and coming closer or coming into contact with each other.

Further, for example, it is preferable for the standby position transfer unit 213 to correct the standby position setting signal so that the distance along the axis X1 from the valve hole 62 to the standby position becomes longer as the viscosity of a liquid supplied to the flow rate adjusting device 100 increases. This is because a higher liquid viscosity causes a lower the liquid flow rate.

In step S110, the pump control unit 220 controls the pump 2 to stop the operation of the pump 2.

In step S111, the on-off valve control unit 230 controls the on-off valve 4 upstream of the flow rate adjusting device 100 so that the on-off valve 4 enters a closed state. In step S112, the on-off valve control unit 230 controls the on-off valve 5 downstream of the flow rate adjusting device 100 so that the on-off valve 5 enters a closed state.

In step S113, the higher-level device 200 determines whether or not to stop the flow rate adjusting system 1 and, if the determination is YES, proceeds with the process to step S114 or, if the determination is NO, performs the process of step S101 again.

In step S114, the higher-level device 200 performs a stop process to stop each unit of the flow rate adjusting system 1 and ends the process of the present flowchart.

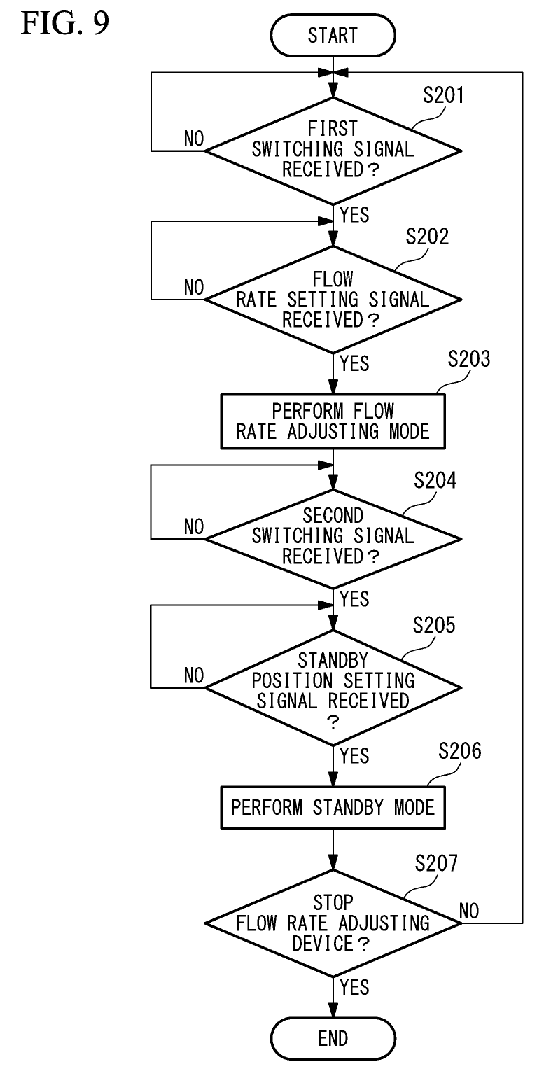

Next, the process performed by the flow rate adjusting device 100 of the present embodiment will be described with reference to FIG. 9. FIG. 9 is a flowchart illustrating the operation performed by the flow rate adjusting device 100. It is assumed that the flow rate adjusting device 100 is performing the standby mode before starting the operation illustrated in FIG. 9.

In step S201, the control unit 31 determines whether or not the first switching signal has been received from the higher-level device 200 and, if the determination is YES, proceeds with the process to step S202 or, if the determination is NO, repeats the process of step S201.

In step S202, the control unit 31 determines whether or not the flow rate setting signal has been received from the higher-level device 200 and, if the determination is YES, proceeds with the process to step S203 or, if the determination is NO, repeats the process of step S202.

In step S203, the control unit 31 controls the flow rate adjusting portion 20 so as to perform the flow rate adjusting mode. The flow rate setting unit 32 sets the set flow rate value FRset based on the flow rate setting signal transferred from the higher-level device 200. When performing the flow rate adjusting mode, the control unit 31 controls the flow rate adjusting portion 20 to move the valve body 21 to a target position that varies in accordance with a flow rate difference between the measured flow rate value FRac of a liquid measured by the ultrasonic flow metering portion 10 and the set flow rate value FRset so that the measured flow rate value FRac matches the set flow rate value FRset set by the flow rate setting unit 32.

In step S204, the control unit 31 determines whether or not the second switching signal has been received from the higher-level device 200 and, if the determination is YES, proceeds with the process to step S205 or, if the determination is NO, repeats the process of step S204.

In step S205, the control unit 31 determines whether or not the standby position setting signal has been received from the higher-level device 200 and, if the determination is YES, proceeds with the process to step S206 or, if the determination is NO, repeats the process of step S205.

In step S206, the control unit 31 controls the flow rate adjusting portion 20 so as to perform the standby mode. When performing the standby mode, the control unit 31 sets a standby position in accordance with the standby position setting signal for the standby position setting unit 33. Further, the control unit 31 controls the flow rate adjusting portion 20 to move the valve body 21 to a standby position at which the valve body 21 is not in contact with the valve hole 62 and then maintain the standby position.

In step S207, the control unit 31 determines whether or not to stop the flow rate adjusting device 100 and, if the determination is YES, ends the process of the present flowchart or, if the determination is NO, performs step S201 again.

Although the control unit 31 proceeds with the process to step S206 to perform the standby mode when the standby position setting signal is received from the higher-level device 200 in the above flowchart, other forms may be employed. For example, even when the standby position setting signal is not received from the higher-level device 200 (for example, when the standby position setting signal has not been received even after a predetermined time has elapsed), the process may proceed to step S206 to perform the standby mode.

In such a case, the higher-level device 200 does not perform the process of step S109 of FIG. 8 (the process of transferring the standby position setting signal). Further, the control unit 31 of the flow rate adjusting device 100 is intended to set a predefined standby position for the standby position setting unit 33. By doing so, the flow rate adjusting device 100 can set a standby position based on the standby position setting signal when the standby position setting signal is received from the higher-level device 200 and can set a predefined standby position when the standby position setting signal is not received from the higher-level device 200.

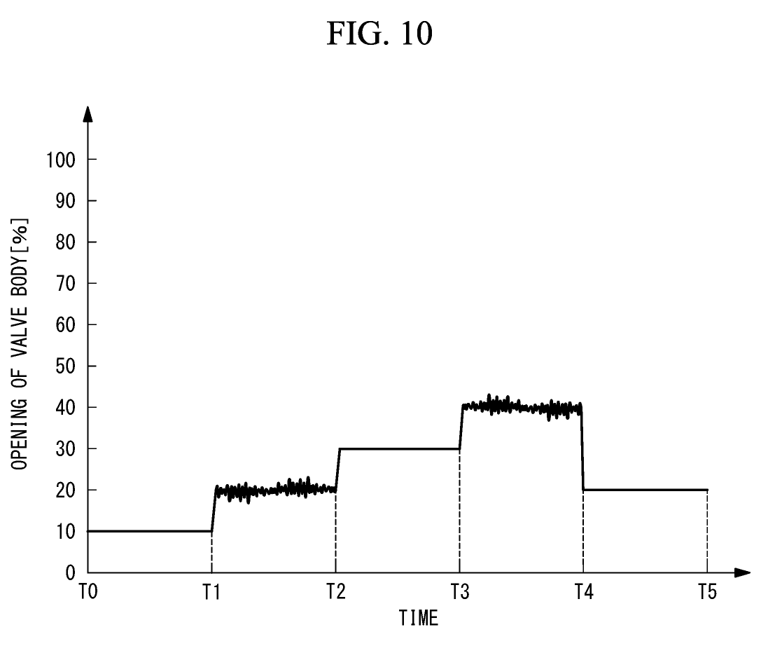

Next, an example of a change in the opening of the valve body 21 will be described with reference to FIG. 10. FIG. 10 is a graph illustrating an example of a change in the opening of the valve body 21. In FIG. 10, the period from time T0 to time T1, the period from time T2 to time T3, and the period from time T4 to time T5 are periods in which the flow rate adjusting device 100 performs the standby mode. Further, in FIG. 10, the period from time T1 to time T2 and the period from time T3 to time T4 are periods in which the flow rate adjusting device 100 performs the flow rate adjusting mode.

In FIG. 10, the opening of the valve body 21 being 0 [%] means a state where the valve body 21 is at the position illustrated by the solid line in FIG. 3 in contact with the valve hole 62. Further, the opening of the valve body 21 being 100 [%] means a state where the valve body 21 is at the position illustrated by the dashed line in FIG. 3.

When the control unit 31 of the flow rate adjusting device 100 of the present embodiment performs the flow rate adjusting mode, the target position that varies in accordance with a flow rate difference between the measured flow rate value FRac and the set flow rate value FRset is set between a lower limit position corresponding to the lower limit value of the set flow rate value FRset that can be set by the flow rate setting unit 32 (the position at which the opening of the valve body 21 is 0 [%]) and an upper limit position corresponding to the upper limit value of the set flow rate value FRset that can be set by the flow rate setting unit 32 (the position at which the opening of the valve body 21 is 100 [%]).

When the control unit 31 of the flow rate adjusting device 100 of the present embodiment performs the flow rate adjusting mode, the target position of the valve body 21 is the position that varies in accordance with a flow rate difference between the measured flow rate value FRac and the set flow rate value FRset. In the example illustrated in FIG. 10, the set flow rate value FRset in the flow rate adjusting mode performed between time T1 and time T2 is set such that the opening of the valve body 21 is 20 [%]. Further, the set flow rate value FRset in the flow rate adjusting mode performed between time T3 and time T4 is set such that the opening of the valve body 21 is 40 [%].

When the control unit 31 of the flow rate adjusting device 100 of the present embodiment performs the standby mode, the standby position at which the valve body 21 is arranged is a position set by the standby position setting unit 33, which is a position more spaced away from the valve hole 62 than the lower limit position. In the example illustrated in FIG. 10, the standby position setting unit 33 sets the standby position in the standby mode performed between time T0 and time T1 to a position corresponding to the opening of 10 [%], sets the standby position in the standby mode performed between time T2 and time T3 to a position corresponding to the opening of 30 [%], and sets the standby position in the standby mode performed between time T4 and time T5 to a position corresponding to the opening of 20 [%],

As illustrated in FIG. 10, to set different standby positions for the standby mode performed between time T0 and time T1, the standby mode performed between time T2 and time T3, and the standby mode performed between time T4 and time T5, respectively, the standby position transfer unit 213 of the higher-level device 200 operates as follows.

The standby position transfer unit 213 transfers the standby position setting signal to the flow rate adjusting device 100 so that the standby position in a predetermined standby mode varies in accordance with the set flow rate value FRset in the flow rate adjusting mode performed subsequent to the predetermined standby mode.

In the example illustrated in FIG. 10, the standby position in the standby mode from time T0 to time T1 is set to a position at which the opening is lower by 10 [%] than for the set flow rate value FRset in the subsequently performed flow rate adjusting mode from time T1 to time T2 (a position corresponding to the opening of 10 [%]). Further, in the example illustrated in FIG. 10, the standby position in the standby mode from time T2 to time T3 is set to a position at which the opening is lower by 30 [%] than for the set flow rate value FRset in the subsequently performed flow rate adjusting mode from time T3 to time T4 (a position corresponding to the opening of 30 [%]).

Although the standby position setting unit 33 sets different standby positions for the standby mode performed between time T0 and time T1, the standby mode performed between time T2 and time T3, and the standby mode performed between time T4 and time T5, respectively, in the example illustrated in FIG. 10, other forms may be employed. For example, the standby position setting unit 33 may set the standby position set in the standby mode to a predefined fixed standby position (for example, a position corresponding to the opening of 10 [%]).

### First Modified Example

In the embodiment described above, a modified example may be provided in which the standby position at which the flow rate adjusting device 100 causes the valve body 21 to stand by in the standby mode is corrected in accordance with the temperature of a liquid flowing through the flow rate adjusting device 100.

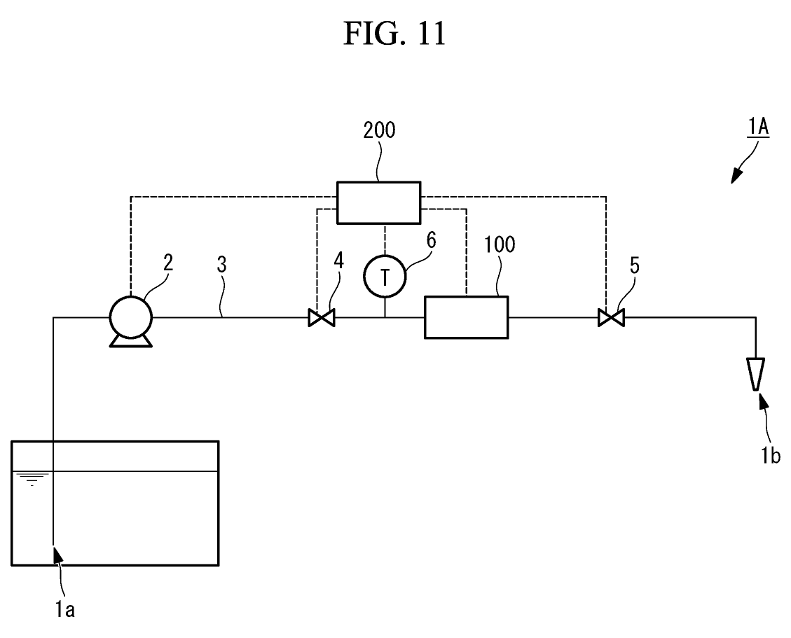

FIG. 11 is a schematic configuration diagram illustrating a flow rate adjusting system 1A according to the first modified example of the present disclosure. The flow rate adjusting system 1A illustrated in FIG. 11 differs from the flow rate adjusting system 1 illustrated in FIG. 6 in that the flow rate adjusting system 1A includes a temperature detecting unit 6 configured to determine the temperature of a liquid flowing into the flow rate adjusting device 100.

In the flow rate adjusting system 1A according to the first modified example of the present disclosure, the standby position transfer unit 213 of the higher-level device 200 corrects the standby position setting signal so that the distance along the axis X1 from the valve hole 62 to the standby position is increased in accordance with a rise in the liquid temperature determined by the temperature detecting unit 6 and transfers the corrected standby position setting signal to the flow rate adjusting device 100.

### Second Modified Example

In the embodiment described above, a modified example may be provided in which the standby position at which the flow rate adjusting device 100 causes the valve body 21 to stand by in the standby mode is corrected in accordance with the pressure of a liquid flowing through the flow rate adjusting device 100.

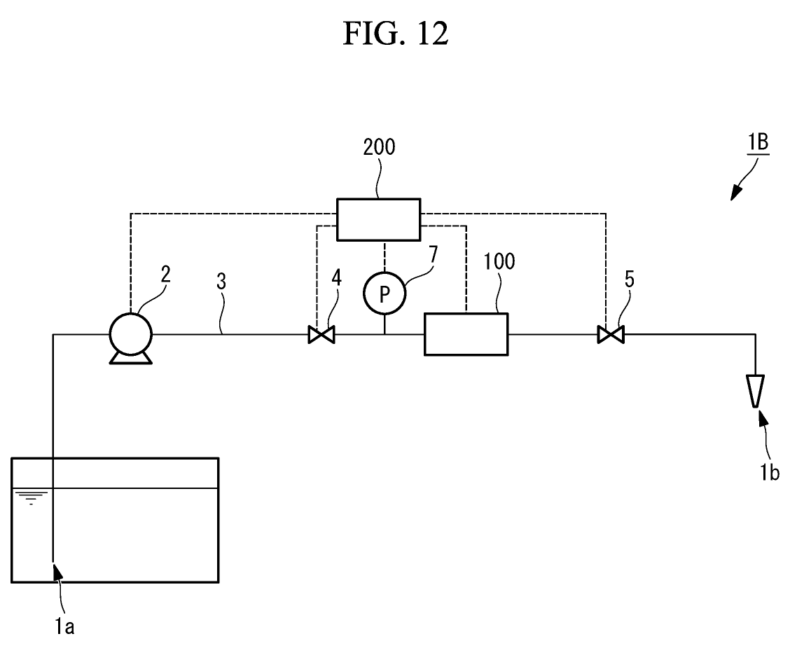

FIG. 12 is a schematic configuration diagram illustrating a flow rate adjusting system 1B according to the second modified example of the present disclosure. The flow rate adjusting system 1B illustrated in FIG. 12 differs from the flow rate adjusting system 1 illustrated in FIG. 6 in that the flow rate adjusting system 1B includes a pressure detecting unit 7 configured to determine the pressure of a liquid flowing into the flow rate adjusting device 100.

In the flow rate adjusting system 1B according to the second modified example of the present disclosure, the standby position transfer unit 213 of the higher-level device 200 corrects the standby position setting signal so that the distance along the axis X1 from the valve hole 62 to the standby position is reduced in accordance with a rise in the liquid pressure determined by the pressure detecting unit 7 and transfers the corrected standby position setting signal to the flow rate adjusting device 100.

### Third Modified Example

In the embodiment described above, a modified example may be provided in which the standby position at which the flow rate adjusting device 100 causes the valve body 21 to stand by in the standby mode is corrected in accordance with the pressure of a liquid flowing through the flow rate adjusting device 100.

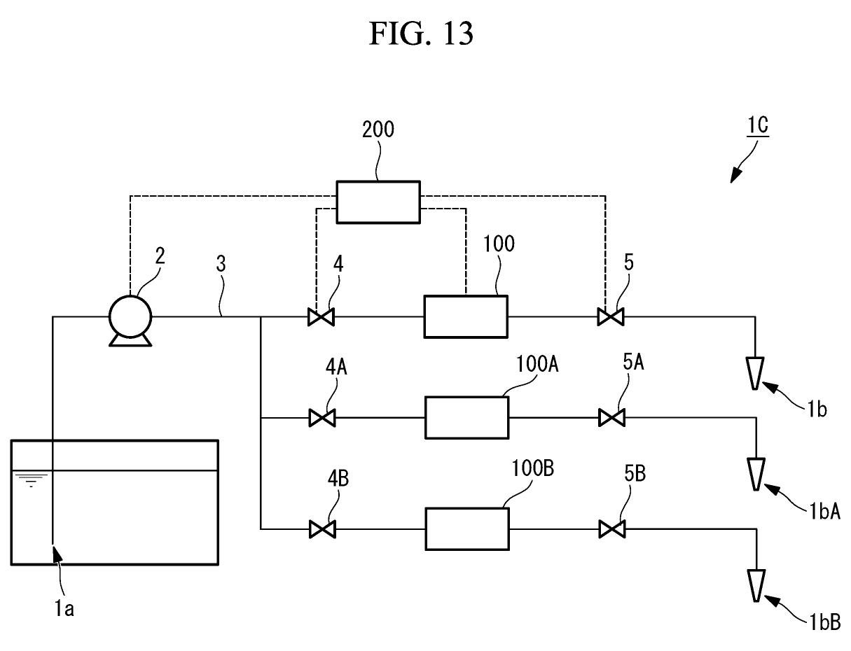

FIG. 13 is a schematic configuration diagram illustrating a flow rate adjusting system 1C according to the third modified example of the present disclosure. The flow rate adjusting system 1C illustrated in FIG. 13 includes the flow rate adjusting device 100, the flow rate adjusting device 100A, and the flow rate adjusting device 100B. An on-off valve 4A is arranged between the piping 3 and the flow rate adjusting device 100A, and an on-off valve 4B is arranged between the piping 3 and the flow rate adjusting device 100B. An on-off valve 5A is arranged between the flow rate adjusting device 100A and an outflow end 1bA, and an on-off valve 5B is arranged between the flow rate adjusting device 100B and the outflow end 1bB.

The flow rate adjusting device 100A adjusts the flow rate of a liquid supplied from the piping 3 to the outflow end 1bA. The flow rate adjusting device 100B adjusts the flow rate of a liquid supplied from the piping 3 to the outflow end 1bB. When the pump 2 is operated at a constant rotational rate, the larger the openings of the on-off valve 4A and the on-off valve 4B are, the lower the pressure of the liquid supplied to the flow rate adjusting device 100 via the on-off valve 4A will be. In contrast, when the pump 2 is operated at a constant rotational rate, the smaller the openings of the on-off valve 4A and the on-off valve 4B are, the higher the pressure of the liquid supplied to the flow rate adjusting device 100 via the on-off valve 4A will be.

In the flow rate adjusting system 1C according to the third modified example of the present disclosure, the standby position transfer unit 213 of the higher-level device 200 corrects the standby position setting signal so that the distance along the axis X1 from the valve hole 62 to the standby position in the flow rate adjusting device 100 is increased in accordance with an increase in the openings of the on-off valve 4A and the on-off valve 4B and transfers the corrected standby position setting signal to the flow rate adjusting device 100. In contrast, in the flow rate adjusting system 1C, the standby position transfer unit 213 of the higher-level device 200 corrects the standby position setting signal so that the distance along the axis X1 from the valve hole 62 to the standby position in the flow rate adjusting device 100 is reduced in accordance with a reduction in the openings of the on-off valve 4A and the on-off valve 4B and transfers the corrected standby position setting signal to the flow rate adjusting device 100.

The effects and advantages achieved by the flow rate adjusting device 100 and the flow rate adjusting system 1 of the present embodiment described above will be described.

According to the flow rate adjusting device 100 of the present embodiment, when performing the standby mode switched from the flow rate adjusting mode, the control unit 31 controls the flow rate adjusting portion 20 to move the valve body 21 to a standby position at which the valve body 21 is not in contact with the valve hole 62 and then maintain the standby position. Since the position at which the valve body 21 is not in contact with the valve hole 62 is the standby position, the opening is larger than that in the fully closed position at which the valve body 21 is in contact with the valve hole 62. Thus, the flow rate better follows the set flow rate value FRset than in the case where the flow rate adjusting mode is applied via switching from the fully closed position, and this can prevent a control delay from occurring. Further, even when the valve body 21 at the switching from the flow rate adjusting mode to the standby mode is excessively spaced away from the valve hole 62 resulting in an excessively large opening, the valve body 21 is moved to the standby position, and the standby position is maintained. Thus, an overshoot due to the excessively large opening of the valve body 21 can be prevented from occurring when the standby mode is switched to the flow rate adjusting mode.

According to the flow rate adjusting device 100 of the present embodiment, since the standby position is a position more spaced away from the valve hole 62 than the lower limit position, the flow rate better follows the set flow rate value FRset than in the case where the flow rate adjusting mode is applied via switching from the lower limit position, and this can prevent a control delay from occurring.

According to the flow rate adjusting device 100 of the present embodiment, the standby position is set to a predetermined position between the lower limit position and the upper limit position by the standby position setting unit 33, and this can suitably prevent an overshoot or a control delay from occurring when the standby mode is switched to the flow rate adjusting mode.

According to the flow rate adjusting device 100 of the present embodiment, switching between the flow rate adjusting mode and the standby mode can be suitably performed in accordance with the first switching signal and the second switching signal received from the higher-level device 200.

According to the flow rate adjusting device 100 of the present embodiment, the set flow rate value FRset can be set based on the flow rate setting signal transferred from the higher-level device 200, and the standby position can be set based on the standby position setting signal transferred from the higher-level device 200.

According to the flow rate adjusting system 1 of the present embodiment, the standby position transfer unit 213 of the higher-level device 200 transfers the standby position setting signal to the flow rate adjusting device 100 so that the standby position in a predetermined standby mode varies in accordance with the set flow rate value FRset in a flow rate adjusting mode performed subsequently to the predetermined standby mode. Since the standby position is a position in accordance with the set flow rate value FRset in the flow rate adjusting mode when a predetermined standby mode is switched to a flow rate adjusting mode, an overshoot or a control delay can be suitably prevented from occurring.

According to the flow rate adjusting system 1A of the first modified example of the present embodiment, since the distance along the axis X1 from the valve hole 62 to the standby position is increased in accordance with a rise in the liquid temperature determined by the temperature detecting unit 6, it is possible to suitably prevent a failure that would otherwise be caused by that the valve body 21 or the valve hole 62 expands and the valve body 21 and the valve hole 62 come closer or come into contact with each other due to a rise in the liquid temperature.

According to the flow rate adjusting system 1B of the second modified example of the present embodiment, since the distance along the above axis from the valve hole to the standby position is reduced in accordance with a rise in the liquid pressure determined by the pressure detecting unit 7, it is possible to suitably prevent the liquid flow rate from being excessively larger due to a rise in the liquid pressure.

What is claimed is:

1. A flow rate adjusting device comprising:
a flow metering portion configured to measure a flow rate of a liquid flowing through a measurement flow channel;
a flow rate adjusting portion configured to move a valve body along an axis in a direction closer to or away from a valve hole to adjust a flow rate of a liquid flowing out of the measurement flow channel;
a flow rate setting unit configured to set a set flow rate value of a liquid to be adjusted by the flow rate adjusting portion; and
a control unit configured to control the flow rate adjusting portion in either a flow rate adjusting mode or a standby mode,
wherein the control unit,
when performing the flow rate adjusting mode, controls the flow rate adjusting portion to move the valve body to a target position that varies in accordance with a flow rate difference between a measured flow rate value of a liquid measured by the flow metering portion and the set flow rate value so that the measured flow rate value matches the set flow rate value, and
when performing the standby mode, controls the flow rate adjusting portion to move the valve body to a standby position and then maintain the standby position, the valve body being not in contact with the valve hole at the standby position.

2. The flow rate adjusting device according to claim 1,
wherein the target position is set between a lower limit position and an upper limit position, the lower limit position corresponding to a lower limit value of the set flow rate value, the upper limit position corresponding to an upper limit value of the set flow rate value, and the flow rate setting unit being configured to set the lower limit value and the upper limit value, and
wherein the standby position is a position more spaced away from the valve hole than the lower limit position.

3. The flow rate adjusting device according to claim 2 further comprising a standby position setting unit configured to set the standby position at a predetermined position between the lower limit position and the upper limit position.

4. The flow rate adjusting device according to claim 1, wherein the control unit switches the standby mode to the flow rate adjusting mode in response to receiving a first switching signal from a higher-level device, the first switching signal being for switching the standby mode to the flow rate adjusting mode, and the control unit switches the flow rate adjusting mode to the standby mode in response to receiving a second switching signal from the higher-level device, the second switching signal being for switching the flow rate adjusting mode to the standby mode.

5. The flow rate adjusting device according to claim 4,
wherein the flow rate setting unit sets the set flow rate value based on a flow rate setting signal transferred from the higher-level device, the flow rate setting signal being for setting the set flow rate value, and
wherein the control unit sets the standby position based on a standby position setting signal transferred from the higher-level device, the standby position setting signal being for setting the standby position.

6. A flow rate adjusting system comprising: a flow rate adjusting device; and a higher-level device configured to control the flow rate adjusting device,
wherein the flow rate adjusting device comprises:
a flow metering portion configured to measure a flow rate of a liquid flowing through a measurement flow channel;
a flow rate adjusting portion configured to move a valve body along an axis in a direction closer to or away from a valve hole to adjust a flow rate of a liquid flowing out of the measurement flow channel;
a flow rate setting unit configured to set a set flow rate value of a liquid to be adjusted by the flow rate adjusting portion; and
a control unit configured to control the flow rate adjusting portion in either a flow rate adjusting mode or a standby mode,
wherein the control unit
when performing the flow rate adjusting mode, controls the flow rate adjusting portion to move the valve body to a target position that varies in accordance with a flow rate difference between a measured flow rate value of a liquid measured by the flow metering portion and the set flow rate value so that the measured flow rate value matches the set flow rate value, and
when performing the standby mode, controls the flow rate adjusting portion to move the valve body to a standby position and then maintain the standby position, the valve body being not in contact with the valve hole at the standby position,
wherein the higher-level device comprises:
a mode transfer unit configured to transfer a first switching signal and a second switching signal to the flow rate adjusting device, the first switching signal being for switching the flow rate adjusting device from the standby mode to the flow rate adjusting mode, and the second switching signal being for switching the flow rate adjusting device from the flow rate adjusting mode to the standby mode;
a flow rate transfer unit configured transfer a flow rate setting signal to the flow rate adjusting device, the flow rate setting signal being for setting the set flow rate value; and
a standby position transfer unit configured to transfer a standby position setting signal to the flow rate adjusting device, the standby position setting signal being for setting the standby position, and
wherein the standby position transfer unit transfers the standby position setting signal to the flow rate adjusting device so that the standby position in a predetermined standby mode varies in accordance with the set flow rate value in the flow rate adjusting mode performed subsequent to the predetermined standby mode.

7. The flow rate adjusting system according to claim 6 further comprising a temperature detecting unit configured to determine a temperature of a liquid passing through the flow rate adjusting device,
wherein the standby position transfer unit transfers the standby position setting signal to the flow rate adjusting device so that a distance along the axis from the valve hole to the standby position is increased in accordance with a rise in the temperature of the liquid determined by the temperature detecting unit.

8. The flow rate adjusting system according to claim 6 further comprising a pressure detecting unit configured to determine a pressure of a liquid flowing into the flow rate adjusting device,
wherein the standby position transfer unit transfers the standby position setting signal to the flow rate adjusting device so that a distance along the axis from the valve hole to the standby position is reduced in accordance with a rise in the pressure of the liquid determined by the pressure detecting unit.

9. A control method of a flow rate adjusting device, wherein the flow rate adjusting device comprises
a flow metering portion configured to measure a flow rate of a liquid flowing through a measurement flow channel,
a flow rate adjusting portion configured to move a valve body along an axis in a direction closer to or away from a valve hole to adjust a flow rate of a liquid flowing out of the measurement flow channel, and
a flow rate setting unit configured to set a set flow rate value of a liquid to be adjusted by the flow rate adjusting portion,
the control method comprising:
a flow rate adjusting step of controlling the flow rate adjusting portion to move the valve body to a target position that varies in accordance with a flow rate difference between a measured flow rate value of a liquid measured by the flow metering portion and the set flow rate value so that the measured flow rate value matches the set flow rate value; and
a standby step of controlling the flow rate adjusting portion to move the valve body to a standby position and then maintain the standby position, the valve body being not in contact with the valve hole at the standby position.
